(19) United States
(12) Patent Application Publication
(10) Pub. No.: US 2017/0295834 A1
(43) Pub. Date: Oct. 19, 2017

(54) All-Natural Bitterness-Reducing Flavor System

(71) Applicant: Alexander LaCroix, Phoenix, AZ (US)

(72) Inventor: Alexander LaCroix, Phoenix, AZ (US)

(21) Appl. No.: 15/356,571

(22) Filed: Nov. 19, 2016

Related U.S. Application Data
(63) Continuation of application No. 62/259,709, filed on Nov. 25, 2015.

(51) Int. Cl. A23L 27/33; A23L 27/10; A23L 33/105; A23L 27/00; A23L 33/00

(52) U.S. Cl. CPC A23L 27/33; A23L 27/10; A23L 33/105; A23L 33/00; A23L 27/00

(57) ABSTRACT

The present invention relates to a flavor system comprised of plant-derived sweeteners, including from Stevia rebaudiana and Thaumatococcus danielli, that when added to a mixture of L-Tyrosine, Acetyl-L-Carnitine, Alpha GPC, Huperzia Serrate PE, Phosphatidylserine, Vinpocetine, Vitamin B-12, Vitamin B-9, and Caffeine Anhydrous, neutralizes the bitterness of said mixture in aqueous form.

### CROSS-REFERENCE TO RELATED APPLICATION

This application claims priority to U.S. Provisional Application No. 62/259,709, filed Nov. 25, 2015, the disclosure of which is incorporated herein by reference in its entirety.

### BACKGROUND OF THE INVENTION

### Field of the Invention

The present invention relates to a novel composition of plant-derived sweeteners, the composition having a particular ratio of derivatives from the Stevia rebaudiana and Thaumatococcus danielli.

### Description of Related Art

Energy drinks (commonly composed of caffeine, B-vitamins and amino acids with added flavors) have grown increasingly popular as a means of cognitive enhancement. However, because energy drinks' cognitive benefits are only tangential (enhancing only alertness directly, and cognitive functions such as focus and memory indirectly), nootropics (herbally-derived substances that directly enhance cognitive functions such as focus and memory) are contemplated by the present inventor as additives to drinks promoting cognitive enhancement. Nootropics, although effective cognitive enhancers, are bitter, creating the need for a mechanism by which they can be rendered palatable.

### SUMMARY OF THE INVENTION

The present invention consists of a flavor system comprised of plant-derived sweeteners including Stevia and Thaumatin, that when added to a mixture of L-Tyrosine, Acetyl-L-Carnitine, Alpha GPC, Huperzia Serrate PE, Phosphatidylserine, Vinpocetine, Vitamin B-12, Vitamin B-9, and Caffeine Anhydrous, neutralizes bitterness typically perceived during the consumption of said mixture in aqueous solution.

### DETAILED DESCRIPTION OF THE INVENTION

An object of the present invention is to provide a method by which nootropic-based, cognition-enhancing supplements can be rendered palatable through the neutralization of bitterness. As a result of intense investigation by the present inventor to solve this problem, the present inventor focused his attention on sweeteners whose effect builds slowly as a means of counteracting bitterness, since bitterness is perceived as an aftertaste due to the anatomy of the human tongue. The present inventor discovered that the derivatives of Stevia rebaudiana and Thaumatococcus danielli, natural sweeteners that possess a property of delayed perception when combined, effectively neutralize and eliminate the bitterness associated with a powdered mixture of L-Tyrosine, Acetyl-L-Carnitine, Alpha GPC, Huperzia Serrate PE, Phosphatidylserine, Vinpocetine, Vitamin B-12, Vitamin B-9, and Caffeine Anhydrous in aqueous solution.

What is claimed is:

1. A flavor system comprised of plant-derived sweeteners including Stevia and Thaumatin, that when added to a mixture of L-Tyrosine, Acetyl-L-Carnitine, Alpha GPC, Huperzia Serrate PE, Phosphatidylserine, Vinpocetine, Vitamin B-12, Vitamin B-9, and Caffeine Anhydrous, neutralizes bitterness typically perceived during the consumption of said mixture in aqueous solution.
